(19) United States
(12) Patent Application Publication
(10) Pub. No.: US 2016/0278128 A1
(43) Pub. Date: Sep. 22, 2016

(54) ENHANCED RACH ALGORITHM FOR MULTI-SIM DEVICES

(71) Applicant: QUALCOMM Incorporated, San Diego, CA (US)

(72) Inventor: Saiprasad Krishnamurthy, Sunnyvale, CA (US)

(21) Appl. No.: 14/663,324

(22) Filed: Mar. 19, 2015

(51) Int. Cl. H04W 74/08; H04B 1/3816; H04W 72/12

(52) U.S. Cl. CPC H04W 74/0833; H04W 72/12; H04B 1/3816; H04W 88/06

(57) ABSTRACT

Systems and methods are described herein for scheduling activities of a first RAT, including, but not limited to, determining a first set of at least one access service class (ASC) associated with a first radio access technology (RAT) based on persistence delay results; selecting, from the first set of at least one ASC, a second set of at least one ASC based on activities of a second RAT; and selecting, from the second set, an assigned ASC based on priority of a data block, the data block being transmittable via the first RAT.

### BACKGROUND

1. Field

Embodiments described herein generally relate to radio access technology (RAT) optimization processes, and more specifically, to optimizing activities of two or more RATs enabled for a same user equipment (UE).

2. Background

A UE, such as a mobile phone device, may be enabled for one or more RATs, such as Frequency Division Multiple Access (FDMA), Time Division Multiple Access (TDMA), Code Division Multiple Access (CDMA), Universal Mobile Telecommunications Systems (UMTS) (particularly, Wideband Code Division Multiple Access (WCDMA), Long Term Evolution (LTE), and the like), Global System for Mobile Communications (GSM), General Packet Radio Service (GPRS), Wi-Fi, Personal Communications Service (PCS), or other protocols that may be used in a wireless communications network or a data communications network. One or more RATs may be enabled by one or a plurality of subscriber identity modules (“SIMs”). For example, a UE may be a multi-SIM UE, in which each of a plurality of SIMs received or otherwise coupled to the multi-SIM UE may support at least one RAT.

Each SIM of the two or more SIMs may enable a RAT in a multi-SIM device. Typically, activities of one RAT may be subject to failure due to de-sensing (interference caused by noise) from another RAT engaged in ongoing, high-priority activities. For example, WCDMA random access channel (RACH) procedures (which include transmitting a preamble, decoding a response, and transmitting a message) may be prone to decode failure due to activities of high-priority GSM/GPRS transmissions. Specifically, the WCDMA RACH procedures may be prone to failures to decode the preamble response via an acquisition indicator channel (AICH). In particular, in a dual-SIM-dual-active (DSDA) device enabled for WCDMA and GSM/GPRS, GSM voice-related transmissions or GPRS high-priority signaling/timing information transmission cannot be deferred or blocked to accommodate AICH of WCDMA. In another example, in a DSDA device enabled for dual WCDMA, preamble transmission of one WCDMA subscription may de-sense AICH decoding of the other WCDMA subscription.

The de-sense may cause delays in completion of the RACH procedures or even complete RACH failure. Thus, performance of a first RAT (e.g., WCDMA) may be negatively impacted by activities of a second RAT (e.g., GSM, GPRS, or the like). In particular, enhancing features such as high speed (HS) RACH may be negatively impacted. Signal activities and measurement reports may be delayed. An intelligent transmission mechanism (e.g., for the first RAT) is needed to improve performance of the first RAT in light of the de-sense due to the second RAT, without adversely affecting the performance of the second RAT.

### SUMMARY

Embodiments described herein relate to assigning an access service class (ASC) or at least one subchannel associated with an ASC to a data block (e.g., a logical channel block) for transmission via a first radio access technology (RAT). In particular, such assignment may be based on activities of a second RAT, which may cause de-sensing to the first RAT. Both the first RAT and the second RAT may be enabled on a same user device (UE). Such assignment may be based on persistence delay processes, which may identify at least one ASC or subchannel that is ready for immediate transmission. The priority of the data block may be taken into account to select the ASC or subchannel appropriate for transmission.

Various embodiments relate to methods for scheduling activities of a first RAT, including, but not limited to, determining a first set of at least one ASC associated with a first RAT based on persistence delay results; selecting, from the first set of at least one ASC, a second set of at least one ASC based on activities of a second RAT; and selecting, from the second set, an assigned ASC based on priority of a data block, the data block being transmittable via the first RAT.

In some embodiments, the first RAT is Wideband Code Division Multiple Access (WCDMA).

In some embodiments, the second RAT is Global System for Mobile Communications (GSM) or General Packet Radio Service (GPRS).

According to some embodiments, the methods further include determining a third set of ASCs based on subscriber identity module (SIM) configuration. The first set is selected from the third set of ASCs.

In various embodiments, the persistence delay results are determined based on a persistence delay number associated with each ASC in the first set.

In some embodiments, each ASC in the first set has a persistence delay number greater than a random number.

In some embodiments, each ASC in the first set is transmittable without standing by for persistence delay.

According to some embodiments, selecting the assigned ASC based on priority of a data block includes selecting a reference ASC based on priority of the data block. The priority of the reference ASC is the same as the priority of the data block.

In various embodiments, selecting the assigned ASC based on priority of a data block further includes determining the assigned ASC based on the reference ASC; and a difference between the priority of the assigned ASC and the priority of the reference ASC is less than a difference between priority of any ASC in the second set and the priority of the reference ASC.

In some embodiments, selecting the second set based on activities of a second RAT includes determining overlap between activities of the second RAT and ASC activities of the first RAT.

In various embodiments, selecting the second set based on activities of a second RAT further includes selecting each of the second set from the first set when the overlap between ASC activities of each of the second set and the activities of the second RAT is below a predetermined threshold.

In various embodiments, the first RAT is undergoing a random access channel (RACH) process.

According to various embodiments, a UE is described, the UE including, but not limited to: a scheduling unit, the scheduling unit is configured to: determine a first set of at least one ASC associated with a first RAT based on persistence delay results; select, from the first set of at least one ASC, a second set of at least one ASC based on activities of a second RAT; and select, from the second set, an assigned ASC based on priority of a data block, the data block being transmittable via the first RAT.

In some embodiments, the scheduling unit is further configured to determine a third set of ASCs based on SIM configuration. The first set is selected from the third set.

In some embodiments, the persistence delay results are determined based on a persistence delay number associated with each ASC in the first set.

In some embodiments, each ASC in the first set has a persistence delay number greater than a random number.

In various embodiments, each ASC in the first set is transmittable without standing by for persistence delay.

According to some embodiments, selecting the assigned ASC based on priority of a data block includes selecting a reference ASC based on priority of the data block. The priority of the reference ASC is the same as the priority of the data block.

In various embodiments, selecting the assigned ASC based on priority of a data block further includes determining the assigned ASC based on the reference ASC; and a difference between the priority of the assigned ASC and the priority of the reference ASC is less than a difference between priority of any ASC in the second set and the priority of the reference ASC.

According to various embodiments, selecting the second set based on activities of a second RAT includes determining overlap between activities of the second RAT and ASC activities of the first RAT.

In some embodiments, selecting the second set based on activities of a second RAT further includes selecting each of the second set from the first set when the overlap between ASC activities of each of the second set and the activities of the second RAT is below a predetermined threshold.

In some embodiments, the first RAT is undergoing a RACH process.

According to various embodiments, systems are described, including, but not limited to, means for determining a first set of at least one ASC associated with a first RAT based on persistence delay results; means for selecting, from the first set of at least one ASC, a second set of at least one ASC based on activities of a second RAT; and means for selecting, from the second set, an assigned ASC based on priority of a data block, the data block being transmittable via the first RAT.

Various embodiments described methods including, but not limited to, determining inadequate RACH performance for a first cell; selecting an assigned cell from at least one second cell based on probability of successful RACH performance; and camping on the assigned cell.

In some embodiments, the methods further includes determining, for the first cell, a first set of at least one associated with a first RAT based on persistence delay results; selecting, from the first set, a second set of at least one ASC based on activities of a second RAT; and selecting, from the second set, a first assigned ASC based on priority of a data block, the data block being transmittable via the first RAT serviced by the first cell.

According to some embodiments, inadequate RACH performance for the first cell is determined when at least one of: the first set fails to be determined, the second set fails to be determined; and the first assigned ASC associated with the first cell fails to be determined.

In some embodiments, the methods further includes determining a fourth set of at least one ASC associated with a first RAT based on persistence delay results for each of the at least one second cell; selecting, from the fourth set, a fifth set of at least one ASC based on activities of a second RAT; and selecting, from the fifth set, a second assigned ASC for each of the at least one second cell based on priority of a data block, the data block being transmittable via the first RAT.

In some embodiments, the probability of successful RACH performance for each of the at least one second cell is determined based on the second assigned ASC.

In various embodiments, the probability of successful RACH performance for each of the at least one second cell is compared.

In some embodiments, one of the at least one second cell having highest probability of successful RACH performance associated with the second assigned ASC associated with the one of the at least one second cell is selected.

### BRIEF DESCRIPTION OF THE DRAWINGS

The accompanying drawings, which are incorporated herein and constitute part of this specification, illustrate exemplary embodiments of the disclosure, and together with the general description given above and the detailed description given below, serve to explain the features of the various embodiments.

FIG. 1 is a schematic diagram of a communication system in accordance with various embodiments.

FIG. 2 is a component block diagram of an example of a user equipment (UE) according to various embodiments.

FIG. 3 is a process flowchart diagram illustrating an example of a scheduling process according to various embodiments.

FIG. 4A is a process flowchart diagram illustrating an example of a scheduling process according to various embodiments.

FIG. 4B is a process flowchart diagram illustrating an example of a process according to various embodiments.

FIG. 5 is a diagram illustrating an example of activity patterns of a second RAT and ASC activities of a first RAT according to various embodiments.

FIG. 6 is a diagram illustrating an example of a persistence delay process according to various embodiments.

FIG. 7 is a process flowchart diagram illustrating an example of a scheduling process according to various embodiments.

FIG. 8 is a flowchart diagram illustrating an example of an ASC selection process according to various embodiments.

FIG. 9 is a component block diagram of a user equipment suitable for use with various embodiments.

FIG. 10 is a flowchart diagram illustrating an example of a base station selection process according to various embodiments.

### DETAILED DESCRIPTION

Various embodiments will be described in detail with reference to the accompanying drawings. Wherever possible, the same reference numbers may be used throughout the drawings to refer to the same or like parts. Different reference numbers may be used to refer to different, same, or similar parts. References made to particular examples and implementations are for illustrative purposes, and are not intended to limit the scope of the disclosure or the claims.

Some modern communication devices, referred to herein as user equipment (UE) or mobile station (MS), may include any one or all of cellular telephones, smart phones, personal or mobile multi-media players, personal data assistants, laptop computers, personal computers, tablet computers, smart books, palm-top computers, wireless electronic mail receivers, multimedia Internet-enabled cellular telephones, wireless gaming controllers, and similar personal electronic devices that include at least one SIM, a programmable processor, memory, and circuitry for connecting to at least two mobile communication networks simultaneously.

A UE may include one or more subscriber identity modules (SIMs) that provide users of the UEs with access to one or multiple separate mobile communication networks. The mobile communication networks are supported by radio access technologies (RATs). Examples of UEs include, but are not limited to, mobile phones, laptop computers, smart phones, and other mobile communication devices of the like that are configured to connect to one or more RATs. Examples of RATs include, but are not limited to, Frequency Division Multiple Access (FDMA), Time Division Multiple Access (TDMA), Code Division Multiple Access (CDMA), Universal Mobile Telecommunications Systems (UMTS) (particularly, Wideband Code Division Multiple Access (WCDMA), Long Term Evolution (LTE), and the like), Global System for Mobile Communications (GSM), General Packet Radio Service (GPRS), Wi-Fi, Personal Communications Service (PCS), or other protocols that may be used in a wireless communications network or a data communications network.

A UE that includes a plurality of SIMs and connects to two or more separate (or same) RATs using a same set of transmission hardware (e.g., radio-frequency (RF) transceivers) is a multi-SIM-multi-standby (MSMS) communication device. In one example, the MSMS communication device may be a dual-SIM-dual-standby (DSDS) communication device, which may include two SIM cards/subscriptions that may both be active on standby, but one is deactivated when the other one is in use. In another example, the MSMS communication device may be a triple-SIM-triple-standby (TSTS) communication device, which includes three SIM cards/subscriptions that may all be active on standby, where two may be deactivated when the third one is in use. In other examples, the MSMS communication device may be other suitable multi-SIM communication devices, with, for example, four or more SIMs, such that when one is in use, the others may be deactivated.

In MSMS cases, usage of the transmission hardware by the RATs may be scheduled to ensure that no overlapping usage occurs. This is because the one set of transmission hardware (e.g., RF resources) may only support communication for one RAT at a given time. Accordingly, intelligent scheduling of usage of the available set of transmission hardware can advance efficient utilization of the transmission hardware, and thus improving communication throughput.

On the other hand, a UE that includes a plurality of SIMs and connects to two or more separate (or some) RATs using two or more separate sets of transmission hardware is termed a multi-SIM-multi-active (MSMA) communication device. An example MSMA communication device is a dual-SIM-dual-active (DSDA) communication device, which includes two SIM cards/subscriptions. Both SIMs may remain active. In another example, the MSMA device may be a triple-SIM-triple-active (TSTA) communication device, which includes three SIM cards/subscriptions. All three SIMs may remain active. In other examples, the MSMA communication device may be other suitable multi-SIM communication devices with four or more SIMs, for which that all SIMs may be active.

Various embodiments are directed to UEs having two or more sets of transmission hardware (e.g., in MSMA cases). Despite that two or more RATs may be both active simultaneously due to having two or more sets of available transmission hardware, each of the two or more RATs may interfere with communication of another one of the RATs (e.g., over de-sense bands). One or more subscriptions (i.e., one or more mobile communication networks each enabled by a RAT) on a UE may negatively affect the performance of other subscriptions operating on the UE. For example, a DSDA communication device (as the UE) may suffer from intra-device interference when an aggressor subscription is transmitting while a victim subscription in the DSDA communication device is simultaneously attempting to receive transmissions.

During a “coexistence event,” the aggressor subscription's transmissions may cause at least some impairment to the victim's ability to receive transmissions. This interference may be in the form of blocking interference, harmonics, intermodulation, and other noises and distortion received by the victim. Such interference may degrade the victim's receiver sensitivity, voice call quality and data throughput. These effects may also result in a reduced network capacity of the UE. Thus, UEs having two or more subscriptions can benefit from embodiments described herein related to efficient scheduling of data traffic.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service with a particular network, the term “SIM” may also be used herein as a shorthand reference to the communication service associated with and enabled by the information (e.g., in the form of various parameters) stored in a particular SIM as the SIM and the communication network, as well as the services and subscriptions supported by that network, correlate to one another.

Systems and methods are described for optimizing random access channel (RACH) processes associated with the first RAT (for a first subscription of the UE) by minimizing negative impact of de-sensing from a second RAT (for a second subscription of the UE). An acquisition indicator channel (AICH), which may be used in downlink, may be used to decode a response to a transmitted preamble of a RACH procedure. In some situations, the AICH decoding (for a first RAT) may fail due to activities of a second RAT (e.g., due to de-sensing), when the AICH decoding for the first RAT overlaps (in time) with the activities of the second RAT. In particular, systems and methods are described herein to minimize or prevent de-sensing due to overlap. As used herein, activities may refer to activity patterns relating to a RAT (e.g., the first RAT, the second RAT, and/or the like). Such activities may include transmission as well as reception.

Typically, an access service class (ASC) may be determined by a media access control (MAC) layer of the UE. Alternatively, the UE may receive the ASC from a radio resource control (RRC). Each SIM may store an access class, which may be a parameter identifying a type of subscriber associated with the UE. Based on the access class, the total set of available ASCs may be determined via mapping as specified in system information block 5 (SIB5). With respect to RACH procedures, the ASC may provide or otherwise designate at least one subchannel on which the UE may transmit a RACH preamble. The UE may decode in downlink AICH decode data. Each ASC (and its corresponding subchannel(s)) may be associated with priority of service for which the RACH request is being made for (e.g., ASC of 0 represents the highest priority, and 7 represents the lowest priority). A reference ASC may be selected based on priority of a data (logical channel) block for which the RACH of the first RAT may be initiated.

A persistence delay process may be initiated. Each ASC may be associated with a delay, which is a time interval before the start of the preamble transmission process (e.g., preamble ramping cycle). The delay may differ from one ASC to another. During the persistence delay process, a random number may be generated periodically (e.g., every 10 ms). When the generated random number is less than the persistence delay associated with an ASC, the ASC is deemed immediately transmittable. Given the delay may decrease when priority of the ASC increase, any ASC with higher priority than the reference ASC may also be deemed immediately transmittable. Accordingly, a set of immediately usable ASCs may be determined the set of immediately usable ASCs may be a subset of the total set of available ASCs. Each ASC within the set of immediately usable ASCs may provide subchannel(s) via which transmission may occur immediately. As such, persistence delay has been taken into account for selecting the set of viable ASCs.

In response to selecting the set of immediately usable ASCs, the UE may query a database including transmission schedule relating to activities of the second RAT (e.g., GSM, GPRS, and the like), when RACH is initiated (for example, by either RRC or MAC). The activities of the second RAT may be expressed in universal time, allowing time unit conversion between the first RAT and the second RAT.

Next, the MAC layer of the UE may select at least one selected ASC from the set of immediately usable ASCs (or a particular RACH subchannel of an ASC) based on the transmission schedule of the second RAT. For example, the selected ASC(s) may be selected such that the activities (e.g., AICH timing on the downlink for response decoding) for the first RAT do not overlap with the activities of the second RAT (e.g., suffers no or minimum de-sensing from the second RAT). A threshold value (e.g., 0% overlap, 10% overlap, or the like) may be implemented to represent an acceptable level of overlap tolerance.

Next, the MAC layer of the UE may examine priority associated with the data block to be transmitted. The MAC layer may assign the data block to one of the selected ASC(s) based on the priority associated with the data block. Out of the selected ASC(s), the MAC layer selects an ASC that meets the priority requirement of the data block. When two or more selected ASC(s) meet the priority requirement of the data block, the ASC having the least overlap with activities of the second RAT, the ASC closest (in priority ranking) to the reference ASC may be selected.

When an ASC includes two or more subchannels, a subchannel may be selected in a similar manner as an ASC is selected. When one out of two or more subchannels of an ASC is selected for transmission, a skipping subchannel process may be used (i.e., only the select subchannel transmits data blocks, while the unselected subchannel(s) is skipped).

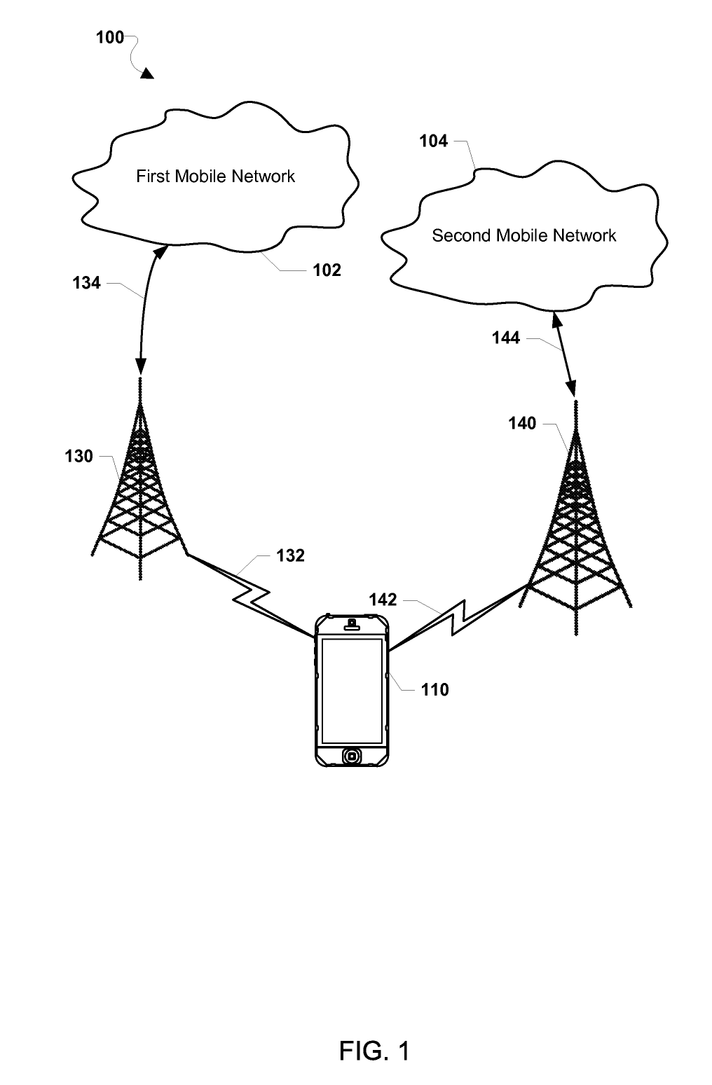

Various embodiments may be implemented within various examples of a communication system 100, such as at least two mobile communication networks, an example of which is illustrated in FIG. 1. A first mobile network 102 and a second mobile network 104 typically each includes a plurality of cellular base stations (e.g., a first base station 130 and a second base station 140). A UE 110 may be in communication with the first mobile network 102 through a first cellular connection 132 to the first base station 130. The UE 110 may also be in communication with the second mobile network 104 through a second cellular connection 142 to the second base station 140. The first base station 130 may be in communication with the first mobile network 102 over a wired or wireless connection 134. The second base station 140 may be in communication with the second mobile network 104 over a wired or wireless connection 144.

The first cellular connection 132 and the second cellular connection 142 may be made through two-way wireless communication links. Each of the wireless communication links may be enable by FDMA, TDMA, CDMA, UMTS (particularly, WCDMA, LTE, and the like), GSM, GPRS, Wi-Fi, PCS, or another protocol used in a wireless communications network or a data communications network. By way of illustrating with a non-limiting example, the first cellular connection 132 may be a WCDMA RAT subscription while the second cellular connection 142 may be a GSM/GPRS RAT subscription. In some embodiments, the first cellular connection 132 and the second cellular connection 142 may be each associated with a different RAT. In other embodiments, the first cellular connection 132 and the second cellular connection 142 may be associated with a same RAT.

Each of the first base station 130 and the second base station 140 may include at least one antenna group or transmission station located in the same or different areas. The at least one antenna group or transmission station may be associated with signal transmission and reception. Each of the first base station 130 and the second base station 140 may include one or more processors, modulators, multiplexers, demodulators, demultiplexers, antennas, and the like for performing the functions described herein. In some embodiments, the first base station 130 and the second base station 140 may be an access point, Node B, evolved Node B (eNode B or eNB), base transceiver station (BTS), or the like.

In various embodiments, the UE 110 may be configured to access the first mobile network 102 and the second mobile network 104 by virtue of the multi-SIM and/or the multi-mode SIM configuration of the UE 110. When a SIM corresponding to a RAT is received in the UE 110, the UE 110 may access the mobile communication network associated with that RAT based on the information stored on the SIM(s).

While the UE 110 is shown connected to the mobile networks 102, 104, in some embodiments (not shown), the UE 110 may include two or more subscriptions to two or more mobile communication networks and may connect to those subscriptions in a manner similar to those described above.

In some embodiments, the UE 110 may establish a wireless connection with a peripheral device (not shown) used in connection with the UE 110. For example, the UE 110 may communicate over a Bluetooth® link with a Bluetooth-enabled personal computing device (e.g., a “smart watch”). In some embodiments, the UE 110 may establish a wireless connection with a wireless access point (not shown), such as over a Wi-Fi connection. The wireless access point may be configured to connect to the Internet or another network over a wired connection.

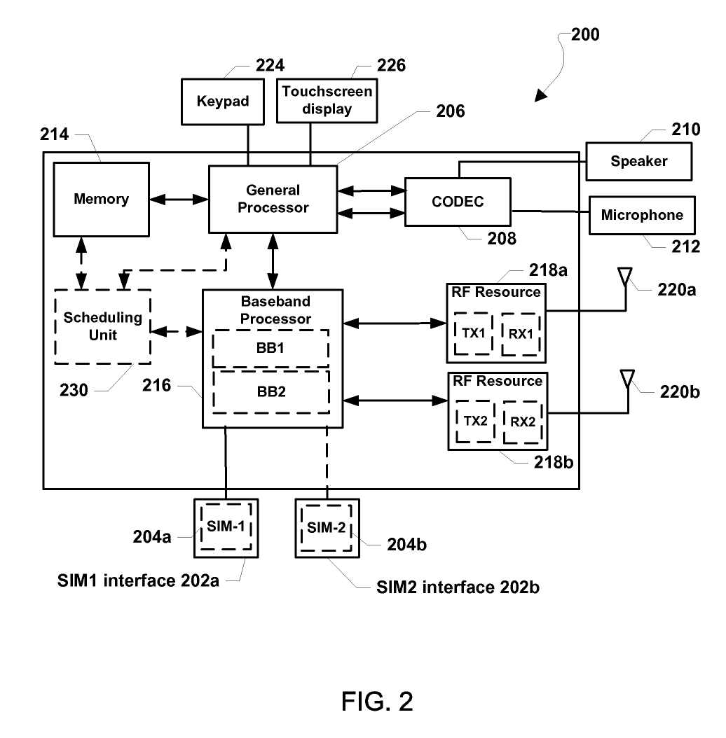

FIG. 2 is a functional block diagram of a UE 200 suitable for implementing various embodiments. According to various embodiments, the UE 200 may be similar to the UE 110 as described with reference to FIG. 1. Referring to FIGS. 1-2, the UE 200 may include a first SIM interface 202a, which may receive a first identity module SIM-1 204a that is associated with a first RAT subscription. The UE 200 may also include a second SIM interface 202b, which may receive a second identity module SIM-2 204b that is associated with a second RAT subscription. In some embodiments, the first RAT subscription may be different from the second RAT subscription. In other embodiments, the first RAT subscription may be a same RAT subscription as the second RAT subscription.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the UE 200, and thus need not be a separate or removable circuit, chip, or card.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The UE 200 may include at least one controller, such as a general purpose processor 206, which may be coupled to a coder/decoder (CODEC) 208. The CODEC 208 may in turn be coupled to a speaker 210 and a microphone 212. The general purpose processor 206 may also be coupled to at least one memory 214. The general purpose processor 206 may include any suitable data processing device, such as a microprocessor. In the alternative, the general purpose processor 206 may be any suitable electronic processor, controller, microcontroller, or state machine. The general purpose processor 206 may also be implemented as a combination of computing devices (e.g., a combination of a digital signal processor (DSP) and a microprocessor, a plurality of microprocessors, at least one microprocessors in conjunction with a DSP core, or any other such configuration).

The memory 214 may be a non-transitory processor-readable storage medium that stores processor-executable instructions. For example, the instructions may include routing communication data relating to the first or second RAT subscription though a corresponding baseband-RF resource chain. The memory 214 may include any suitable internal or external device for storing software and data. Examples of the memory 214 may include, but are not limited to, random access memory RAM, read only memory ROM, floppy disks, hard disks, dongles or other recomp sensor board (RSB) connected memory devices, or the like. The memory 214 may store an operating system (OS), user application software, and/or executable instructions. The memory 214 may also store application data, such as an array data structure.

The general purpose processor 206 and the memory 214 may each be coupled to at least one baseband modem processor 216. Each SIM in the UE 200 (e.g., the SIM-1 202a and the SIM-2 202b) may be associated with a baseband-RF resource chain. A baseband-RF resource chain may include the baseband modem processor 216, which may perform baseband/modem functions for communications on at least one SIM, and may include one or more amplifiers and radios, referred to generally herein as RF resources 218a, 218b (e.g., the first RF resource 218a and the second RF resource 218b). In some embodiments, baseband-RF resource chains may share the baseband modem processor 216 (i.e., a single device that performs baseband/modem functions for all SIMs on the UE 200). In other embodiments, each baseband-RF resource chain may include physically or logically separate baseband processors (e.g., BB1, BB2).

The RF resources 218a, 218b may each be transceivers that perform transmit/receive functions for the associated SIMs of the UE 200. The RF resources 218a, 218b may include separate transmit and receive circuitry, or may include a transceiver that combines transmitter and receiver functions. The RF resources 218a, 218b may each be coupled to a wireless antenna (e.g., a first wireless antenna 220a or a second wireless antenna 220b). The RF resources 218a, 218b may also be coupled to the baseband modem processor 216.

For simplicity, the first RF resource 218a (as well as the associated components) may be associated with the first RAT subscription as enabled by the SIM-1 202a. For example, the first RF resource 218a may be configured to transmit/receive data via the first RAT. The second RF resource 218b may be associated with the second RAT subscription as enabled by the SIM-2 202b. For example, the second RF resource 218b may be configured to transmit/receive data via the second RAT.

In some embodiments, the general purpose processor 206, the memory 214, the baseband processor(s) 216, and the RF resources 218a, 218b may be included in the UE 200 as a system-on-chip. In some embodiments, the first and second SIMs 202a, 202b and their corresponding interfaces 204a, 204b may be external to the system-on-chip. Further, various input and output devices may be coupled to components on the system-on-chip, such as interfaces or controllers. Example user input components suitable for use in the UE 200 may include, but are not limited to, a keypad 224, a touchscreen display 226, and the microphone 212.

In some embodiments, the keypad 224, the touchscreen display 226, the microphone 212, or a combination thereof, may perform the function of receiving a request to initiate an outgoing call. For example, the touchscreen display 226 may receive a selection of a contact from a contact list or receive a telephone number. In another example, either or both of the touchscreen display 226 and the microphone 212 may perform the function of receiving a request to initiate an outgoing call. For example, the touchscreen display 226 may receive a selection of a contact from a contact list or to receive a telephone number. As another example, the request to initiate the outgoing call may be in the form of a voice command received via the microphone 212. Interfaces may be provided between the various software modules and functions in the UE 200 to enable communication between them, as is known in the art.

In some embodiments (not shown), the UE 200 may include, among other things, additional SIM cards, SIM interfaces, a plurality of RF resources associated with the additional SIM cards, and additional antennae for connecting to additional mobile networks.

The UE 200 may include a scheduling unit 230 configured to manage and/or schedule utilization of the RF resources 218a, 218b. For example, the scheduling unit 230 may determine an ASC (or a particular subchannel) for transmitting a data block via a first RAT (as enabled by the SIM-1 202a). In particular embodiments, the scheduling unit 230 may determine the ASC (or subchannel) based on activities of a second RAT (as enabled by the SIM-2 202b), the persistence delay processes, and/or priority associated with the data block.

In some embodiments, the scheduling unit 230 may be implemented within the general purpose processor 206. In some embodiments, the scheduling unit 230 may be implemented as a software application stored within the memory 214 and executed by the general purpose processor 206. Accordingly, such embodiments can be implemented with minimal additional hardware costs. However, other embodiments relate to systems and process that are implemented with dedicated device hardware specifically configured for performing operations described herein. For example, the scheduling unit 230 may be implemented as a separate hardware component (i.e., separate from the general purpose processor 206). For example, the scheduling unit 230 may be coupled to the memory 214, the general processor 206, and/or the baseband processor 216 for performing the function described herein. The scheduling unit 230 may include (or coupled to) the MAC layer and/or the RRC.

Hardware and/or software for the functions may be incorporated in the UE 200 during manufacturing, for example, as part of the original equipment manufacturer's (“OEM's”) configuration of the UE 200. In further embodiments, such hardware and/or software may be added to the UE 200 post-manufacture, such as by installing one or more software applications onto the UE 200.

De-sense of the first RAT may occur when data associated with the second RAT subscription is actively being transmitted (or received) via the second RF resource 218b. Such active transmission (or reception) may interfere with desired activity on the first RF resource 218b associated with the first RAT subscription. In a non-limiting example, uplink data transmitted via GSM/GPRS may interfere with receiving activities on a different transmit/receive chain that may be associated with WCDMA. The desired signals may become corrupted and difficult/impossible to decode. Further, noise from the second RF resource 218b may be detected by a power monitor (not shown) that measures the signal strength of surrounding cells, which may cause the UE 200 to falsely determine the presence of a nearby cell site.

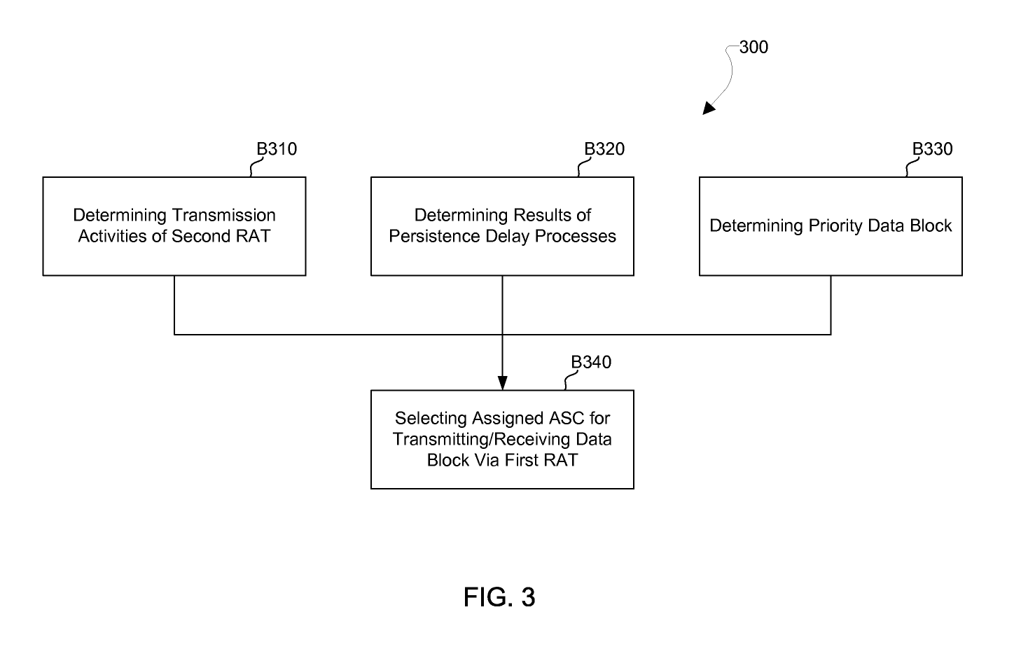

FIG. 3 is a process flowchart diagram illustrating an example of a scheduling process 300 according to various embodiments. Referring to FIGS. 1-3, the scheduling process 300 may be performed by the scheduling unit 230 of the UE 200 according to some embodiments. The scheduling process 300 may be implemented to minimize or prevent de-sensing impairment on the first RAT as caused by the second RAT.

At block B310, the scheduling unit 230 may determine activities of the second RAT. The activities (e.g., transmission/reception patterns, blanking patterns, and/or the like) may be determined and stored in advance. When the second RAT is undergoing activities, the first RAT is likely de-sensed at the same time given simultaneous usage (e.g., overlap) of the first RAT and the second RAT.

At block B320, the scheduling unit 230 may determine results of persistence delay processes. Generally, the results (i.e., the persistence delay) of the persistence delay processes indicate whether an ASC may transmit a RACH preamble immediately. In other words, the persistence delay is a delay time for which the UE 200 is to wait before transmitting a RACH preamble. Without determining the persistence delay, it may be difficult to affirmatively determine whether an ASC (or a subchannel therein) is capable of avoiding the overlap in usage. The persistence delay is a function of ASC (e.g., priority associated therewith). Persistence delay is only fixed (deterministic) for ASC[0]. The persistence delay for all other ASCs may vary based on random number processes.

At block B330, the scheduling unit 230 may determine a priority associated with a data block desired to be transmitted/received via the first RAT. The data block may be any suitable data unit having various types of content. In some embodiments, the data block may be a logical channel block. The priority associated with the data block may be predetermined and stored in a memory (e.g., the memory 214). The priority associated with each type of data block may be stored as a mapping table.

Subsequent to at least one of blocks B310, B320, and B330, the scheduling unit 230 may select an assigned ASC (or an assigned subchannel associated therewith) for transmitting the data block via the first RAT, at block B340. In some embodiments, the selecting at block B340 may be executed based on at least one of: (1) the activities of the second RAT (as determined at block B310), (2) the results of the persistence delay processes (as determined at block B320), and (3) the priority of the data block (as determined at block B330).

In particular, the scheduling unit 230 may start the scheduling process 300 with a set of available ASCs. The available ASCs may be determined based on information stored on the SIM (e.g., the SIM-1 204a) associated with the first RAT. Based on the activities of the second RAT, one or more of the available ASCs may be removed from the set of available ASCs due to overlap with the activities of the second RAT. Based on the results of the persistence delay processes, one or more of the ASCs may be removed from the set given the removed ASCs cannot be used immediately (and have to wait for another delay cycle).

Based on the priority of the data block, one of the remaining ASCs in the set (after blocks B310 and B320 have been executed and some of the available ASCs have been removed) may be selected as the assigned ASC for transmission/reception. Each ASC may be associated with a priority level (e.g., from 0-7, with 0 being the highest priority). When a certain ASC having a priority level that is the same as the priority level associated with the data block, that ASC may be selected as the assigned ASC. When the ASC having the same priority level as the data block had already been removed (e.g., in blocks B310 or B320), the ASC with the closest priority level may be selected as the assigned ASC.

Accordingly, the blocks B310 and B320 may be executed sequentially in any suitable order to remove at least one ASC from the set of ASCs. Next, one of the remaining ASCs (not removed by processes in blocks B310 and B320) may be selected at block B340 based on the priority associated with the data block, as determined at block B330. Therefore, in some embodiments, block B330 may be executed concurrently with either block B310 or B320. In other embodiments, block B330 may be executed sequential to block B310, B320, or both. Block B330 may also be executed before either block B310 or B320.

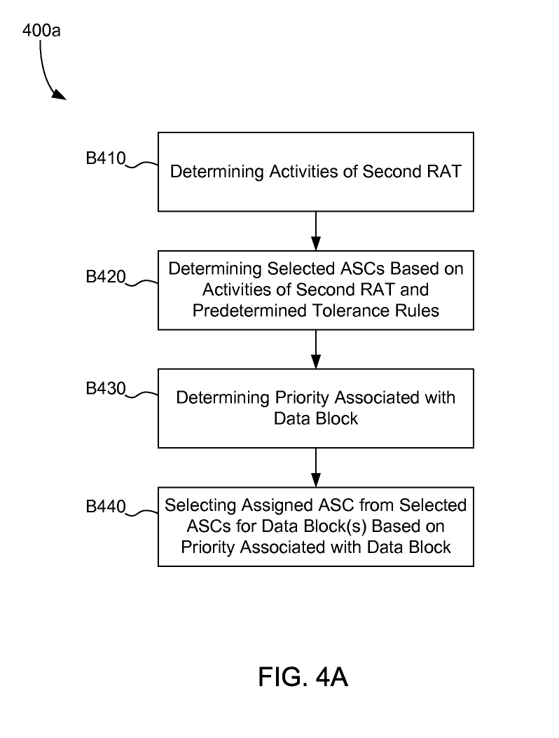

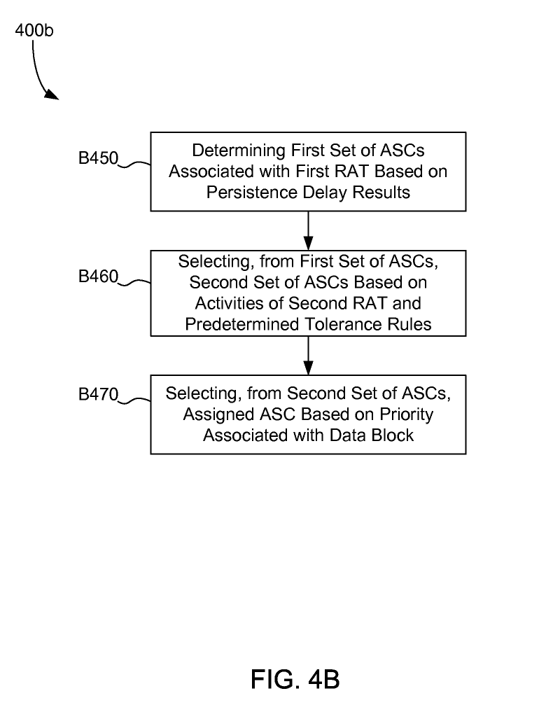

FIG. 4A is a process flowchart diagram illustrating an example of a scheduling process 400a according to various embodiments. Referring to FIGS. 1-4A, the scheduling process 400a may be performed by the scheduling unit 230 of the UE 200. In various embodiments, the scheduling process 400a may be a particular and partial implementation of the scheduling process 300. For example blocks B410 and B420 may correspond to (i.e., as a non-limiting example of a particular implementation of) block B310. Block 430 may correspond to (i.e., as a non-limiting example of a particular implementation of) block B330. Block B440 may correspond to (i.e., as a non-limiting example of a particular implementation of) block B340.

First at block B410, the scheduling unit 230 may determine activities of the second RAT. The scheduling unit 230 may determine the activities of the second RAT in a manner such as, but not limited to, described with respect block B310. For example, when the RRC or MAC initiates RACH processes for the first RAT, the scheduling unit 230 may query a database (stored in the memory 214 or other suitable memory device) containing activities of the first RAT. In particular, activities of the second RAT may be scheduled before such activities actually take place. The activities may also be periodic and/or cyclic in nature. Therefore, activities of the second RAT in relation to time may be determined in advance. The activities may be determined and stored with respect to universal timing instead of any timing specific to the second RAT. In this manner, the scheduling unit 230 may translate activities in universal timing to activities in a timing that is specific to the first RAT.

Next at block B420, the scheduling unit 230 may determine at least one selected ASC based on the activities of the second RAT and predetermined tolerance rules. Depending on activities of the second RAT (e.g., periodicity, timing alignment, and/or the like), which may be determined in advance, a portion of a given ASC (or a subchannel associated therewith) may be de-sensed due to overlapping of activities in time. The at least one selected ASC may include one or more ASCs (associated with the first RAT) allotted a time interval having no or minimum overlap with the activities of the second RAT.

In other words, the at least one selected ASC may be at least one ASC not exceeding a tolerance threshold for overlapping with the activities of the second RAT. The tolerance threshold may be defined by the predetermined tolerance rules. In some embodiments, the predetermined tolerance rules may be selecting only the ASCs (or the subchannels) having 0% overlap with the activities of the second RAT. In other embodiments, the predetermined tolerance rules may allow overlap up to 1%, 5%, 10%, 15%, 20%, or the like. The ASC(s) not selected at block B420 may be removed from the set and not considered further, given that the unselected ASC(s) may be deemed ineligible for first-RAT activities as indicated by failing the tolerance threshold.

In some embodiments, the predetermined tolerance rules may be determined dynamically based on heuristics. For example, the scheduling unit 230 may be configured for system learning. Previous activities overlap percentage may be stored by the scheduling unit 230 in the memory 214 or other suitable memory device as entries. Corresponding to each entry, the scheduling unit 230 may store whether corresponding activities (e.g., RACH procedures) of the first RAT are successful or not. Based on such statistics, the scheduling unit 230 may determine a threshold percentage overlap exceeding which the activities of the first RAT is most likely or certain to fail. For example, the determined threshold may be a percentage overlap above which no activities of the first RAT may be successful, as determined based on the stored entries. In another example, the determined threshold may be a percentage overlap above which the success rate of previous activities is below a predefined percentage (e.g., 75%, 60%, 50%, 25%, 10%, and the like). The determined threshold may be the predetermined tolerance rules.

In some embodiments, the predetermined tolerance rules may be applied irrespective of field conditions. The field conditions may include, but are not limited to, motion of the UE 200, signal strength, interference from other sources, a combination thereof, and the like. In other embodiments, the predetermined tolerance rules may be adjusted more strict or relaxed based on the field conditions.

Next at block B430, the scheduling unit 230 may determine the priority associated with a data block. The data block may be a unit of data desired to be transmitted or received via one or more ASCs (or subchannels associated therewith). For example, the priority may be determined in a manner similar to as described with respect to block B330. In particular, a priority level associated with a data block may correspond to a priority level associated with a particular ASC. Block B430 may be executed at any time before block B440. For example, block B430 may be executed before block B410, after block B410, after block B420, or concurrent with block B410 or 420.

Next at block B440, the scheduling unit 230 may select an assigned ASC from the at least one selected ASC for the data block based on the priority associated with the data block. Out of the selected ASCs as determined in block B420, one may be selected as the assigned ASC for the data block. As described, each data block may be associated with a priority level that also corresponds to a priority level associated with a particular ASC.

Generally, the ASC (or the subchannel associated therewith) having a priority level closest to the priority level of the data block may be selected as the assigned ASC (or subchannel). For instance, whereas a first ASC with a priority level that is the same as the priority level associated with the data block is one of the at least one selected ASC, the first ASC may be selected as the assigned ASC for the data block. On the other hand, whereas none of the at least one selected ASC has a priority level that is the same as the priority level associated with the data block, the ASC with a priority level having the least numerical difference with the priority level of the data block may be selected. In other words, the assigned ASC (or subchannel) may be the closest to the ASC (or subchannel) selected in a single-SIM single-RAT context, in which de-sensing of the only RAT would not have occurred.

By way of illustrating with a non-limiting example, a first logical channel data block may be associated with a priority level 2. A first set of selected ASCs may include ASC [1] (associated with priority level 1), ASC[2] (associated with priority level 2), ASC[4] (associated with priority level 4), and ASC[6] (associated with priority level 6). Given that the ASC[2] is associated with priority level 2, ASC[2] may be selected as the assigned ASC for the first logical channel data block. In another non-limiting example, the second set of at least one selected ASC may include ASC [1], ASC[4], and ASC[6]. In this example, ASC[1] may be selected, given that the numerical difference (e.g., 1) between the priority level of ASC[1] (e.g., 1) and the priority level of the first logical channel data block (e.g., 2) is the least among the elements of the second set.

In yet another non-limiting example, two ASCs with priority levels having the same numerical difference with the priority level of the data block may be present in the set of selected ASCs. In such example, the scheduling unit 230 may select the ASC with the higher priority level, the ASC with the lower priority level, or both.

FIG. 4B is a process flowchart diagram illustrating an example of a process 400b according to various embodiments. Referring to FIGS. 1-4B, the process 400b may be performed by the scheduling unit 230 of the UE 200. In various embodiments, the process 400b may be a particular and partial implementation of the scheduling process 300. For example block B450 may correspond to (i.e., as a non-limiting example of a particular implementation of) block B320. Block B460 may correspond to (i.e., as a non-limiting example of a particular implementation of) block B310. Block B470 may correspond to (i.e., as a non-limiting example of a particular implementation of) block B330.

First at block B450, the scheduling unit 230 may determine a first set of ASCs associated with a first RAT based on persistence delay results, as described. Next, the scheduling unit 230 may select, from the first set of ASCs, a second set of ASCs based on the activities of a second RAT, in the manner described, at block B460. Next at block B470, the scheduling unit 230 may select, from the second set of ASCs, an assigned ASC based on priority associated with a data block transmittable via the first RAT.

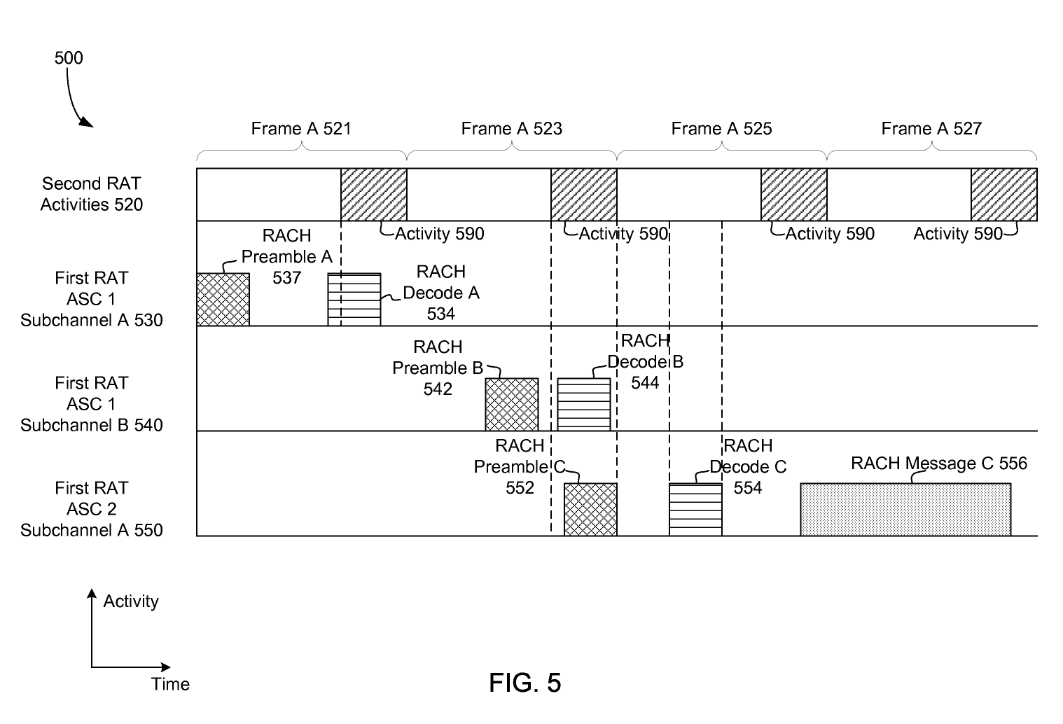

FIG. 5 is a diagram 500 illustrating an example of activity patterns of a second RAT and ASC activities of a first RAT according to various embodiments. Now referring to FIGS. 1-5, FIG. 5 illustrates determining the selected ASCs based on activities of the second RAT (as described with respect to blocks B310, B340, B410, and B420).

The diagram 500 illustrates second RAT activities 520 on an axis representing time. The second RAT activities 520 may include 4 frames of the second RAT, frame A 521, frame B 523, frame C 525, and frame D 527. The second RAT activities 520 may refer to activities 590, which may be transmission or reception activities (periodic in nature). Timing allocation for a first RAT ASC 1 subchannel A 530, first RAT ASC 1 subchannel B 540, and first RAT ASC 2 subchannel A 550 may be shown on a same time axis.

The first RAT and the second RAT may be implemented with any suitable RAT. In the particular example illustrated by the diagram 500, the first RAT may be engaged in the RACH procedure. One of ordinary skill in the art would appreciate that embodiments described herein relate to transmission/reception activities of the first RAT other than to the RACH procedures, as shown in the diagram 500.

A RACH procedure (e.g., of WCDMA) may include transmitting preamble and decoding a message in downlink. The RACH procedure may be completed and deemed successful when a network acknowledgement indication received on the downlink AICH channel is successfully decoded by the UE 200. As shown in the non-limiting example illustrated by the diagram 500, overlap between the activities 590 of the second RAT activities 520 and the RACH decode instances (e.g., RACH decode A 534, RACH decode B 544, RACH decode C 554, and/or the like) may be determined.

The first RAT ASC 1 subchannel A 530 may allow transmitting a RACH preamble A 537 at the designated time allotment as shown. The RACH decode A 534, which corresponds to the RACH preamble A 532, may be decoded at a subsequent time. The RACH decode A 534 may overlap substantially (e.g., 80% overlap) with the activities 590 occurring in frame A 521. Where the predetermined tolerance rules indicate a maximum acceptable percentage overlap of less than 80% (which is usually the case, given that 80% overlap is substantial), the first RAT ASC 1 subchannel A 530 may not be selected as a selected ASC subchannel.

The first RAT ASC 1 subchannel B 540 may allow transmitting a RACH preamble B 542 at the designated time allotment as shown. The RACH decode B 544, which corresponds to the RACH preamble B 542, may be decoded at a subsequent time. The RACH decode B 544 may overlap entirely with the activities 590 occurring at frame B 523. Therefore, the first RAT ASC 1 subchannel B 540 may not be selected as a selected ASC subchannel.

In a non-limiting example, the first RAT ASC 1 may correspond to two subchannels (the first RAT ASC 1 subchannel A 530 and the first RAT ASC 1 subchannel B 540). Given that both the first RAT ASC 1 subchannel A 530 and the first RAT ASC 1 subchannel B 540 may not be selected given the overlap, the first RAT ASC 1 as a whole may not be selected. This is because no available subchannel corresponding to the first RAT ASC 1 is appropriate, as determined based on the overlap and the predetermined tolerance rules.

The first RAT ASC 2 subchannel A 550 may be a subchannel associated with ASC 2, a different ASC from ASC 1. The first RAT ASC 2 subchannel A 550 may allow transmitting a RACH preamble C 552 at the designated time allotment as shown. The RACH decode C 554, which corresponds to the RACH preamble C 552, may be decoded at a subsequent time. The RACH decode C 534 does not overlap with the activities 590. Thus, the RAT ASC 2 subchannel A 550 may be determined as a selected ASC and/or subchannel. As shown, a RACH message C 556 may be transmitted subsequent to successful decoding of the RACH decode C 534.

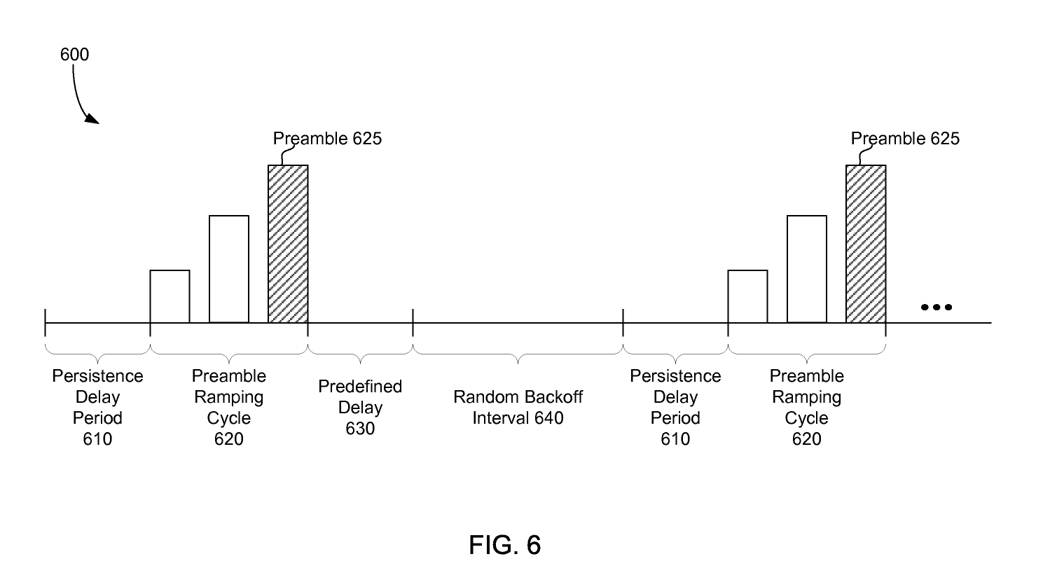

FIG. 6 is a diagram 600 illustrating an example of a persistence delay process according to various embodiments. Referring to FIGS. 1-6, in a RACH process, the UE 200 may be required to standby for a predetermined time interval (e.g., persistence delay 610) before sending a preamble 625. The persistence delay process may be based on a randomly (pseudo-randomly) generated number and therefore cannot be determined in advance. Each ASC may be associated with a persistence delay number in the range 0-1. The persistence delay number may be a function of the priority level of the corresponding ASC. ASC[0] is associated with the persistence delay number 1. Each of ASC[1]-ASC[7] is associated with a persistence delay number greater than 0 and less than 1, in decreasing order.

First, the persistence delay process is initiated and the UE 200 stands by during the persistence delay period 610. The persistence delay period 610 (e.g., 40 ms) may be determined based on the persistence delay number associated with each ASC. During the persistence delay period 610, a random (pseudo-random) number may be generated. ASC(s) with persistence delay number(s) greater than or equal to the random number may be used immediately. Such ASC(s) may initiate a preamble ramping cycle 620 in which the preamble 625 may be transmitted. After transmission of the preamble 625, the UE 200 may stand by for a predefined delay 630 (e.g., 10 ms). After a random backoff interval 640 (e.g., 50 ms), the persistence delay process may be initiated again, from the persistence delay period 610 and then the preamble ramping cycle 620.

On the other hand, when no ASC has a persistence delay number greater than or equal to the random number, the preamble ramping cycle 620 and the preamble 625 are not executed. Instead, the UE 200 may stand by for the predefined delay 630. Then, the persistence delay process may be initiated again, from the persistence delay 610 in which a new random number is generated.

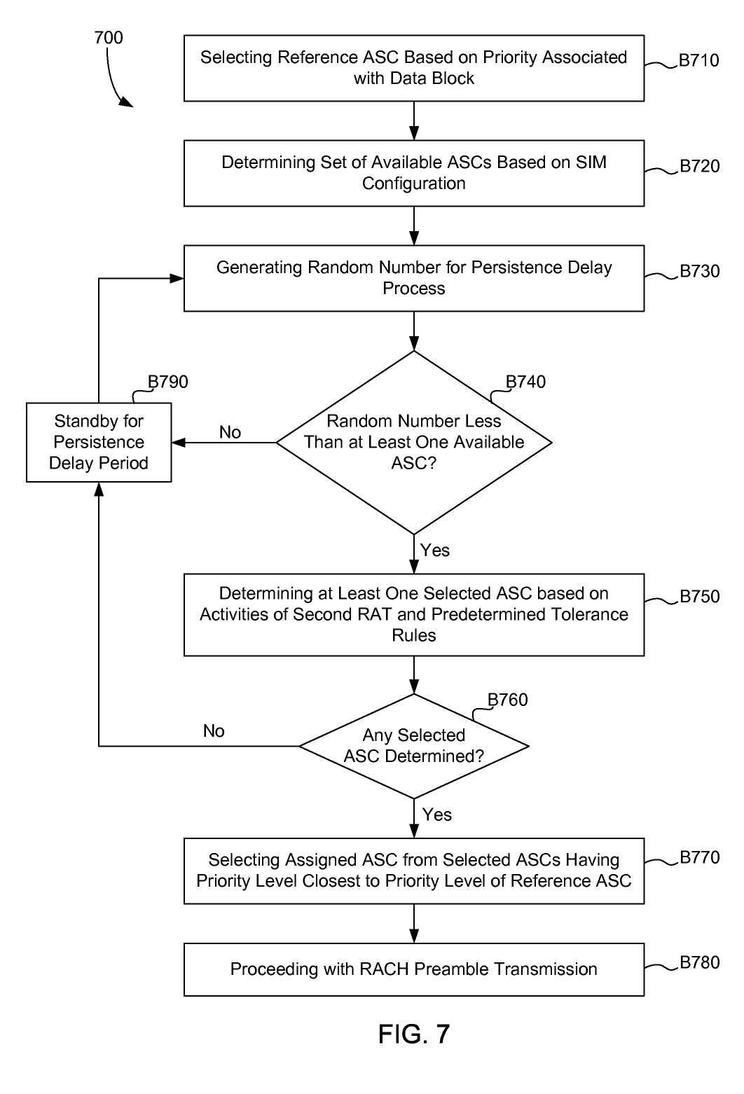

FIG. 7 is a process flowchart diagram illustrating an example of a scheduling process 700 according to various embodiments. Referring to FIGS. 1-7, the scheduling process 700 may be a process for scheduling activities of a first RAT based on activities of a second RAT, results persistence delay processes of the first RAT, and the priority of the data block to be transmitted/received via the first RAT. In particular, the scheduling process 700 may be a particular implementation of the scheduling process 300.

First at block B710, the scheduling unit 230 may select (and store, in the memory 214) a reference ASC based on a priority level associated with the data block. The priority level associated with the data block may be determined in a manner such as, but not limited to, described with respect to block B330. The MAC layer or the RRC may determine the reference ASC. For example, the reference ASC may be associated with a priority level that is the same as a priority level of the data block. In other words, the reference ASC may be an ASC that would have been selected in the single SIM single RAT scenario, without considering de-sensing.

Next at block B720, the scheduling unit 230 may determine a set of available ASCs based on SIM configuration. Some ASCs may not be available for a given RAT. The scheduling unit 230 may determine, based on the parameters stored on the SIM associated with the first RAT (e.g., SIM-1 204a), a set of available ASCs from the complete set of ASCs.

Next at block B730, the scheduling unit 230 may generate a random number for the persistence delay process. The persistence delay process may be the process illustrated by the diagram 600. Subsequently at block B740, the scheduling unit 230 may determine whether the random number is less than (or equal to) the persistence delay number of at least one of the available ASCs (determined at block B720).

Whereas the random number is not less than (or equal to) the persistence delay number of any of the available ASCs, the scheduling unit 230 may stand by for the persistence delay period 610 at block B790 (B740: NO). Following block B790, the scheduling unit 230 may, again, generate a random number for the persistence delay process at block B730.

On the other hand, when the random number is less than (or equal to) the persistence delay number of at least one of the available ASCs, the scheduling unit 230 may determine at least one selected ASCs based on the activities of the second RAT and the predetermined tolerance rules, at block B750 (B740: YES). The at least one of the available ASCs having the persistence delay number greater than (or equal to) the random number is referred to as at least one immediately usable ASC. Out of the at least one immediately usable ASC, the at least one selected ASCs may be selected based on activities of the second RAT and predetermined tolerance rules in a manner similar to described with respect to blocks B310, B410, B420, and diagram 500.

Next at block B760, the scheduling unit 230 may determine whether there are any selected ASC determined at block B750. For example, all of the at least one immediately usable ASC may fail the predetermined tolerance rules given the activities of the second RAT. This would result in the set of at least one selected ASC to contain no elements. When no selected ASC is determined, the scheduling unit 230 may stand by for the persistence delay period 610 at block B790 (B760: NO). Following block B790, the scheduling unit 230 may, again, generate a random number for the persistence delay process at block B730.

On the other hand, when the at least one immediately usable ASC is determined to be a selected ASC (B760: YES), the scheduling unit 230 may select an assigned ASC from the at least one selected ASC, at block B770. The assigned ASC may have a priority level closest to the priority level of the reference ASC. Next at block B780, the scheduling unit 230 may proceed with the RACH preamble transmission (e.g., the preamble ramping cycle 620).

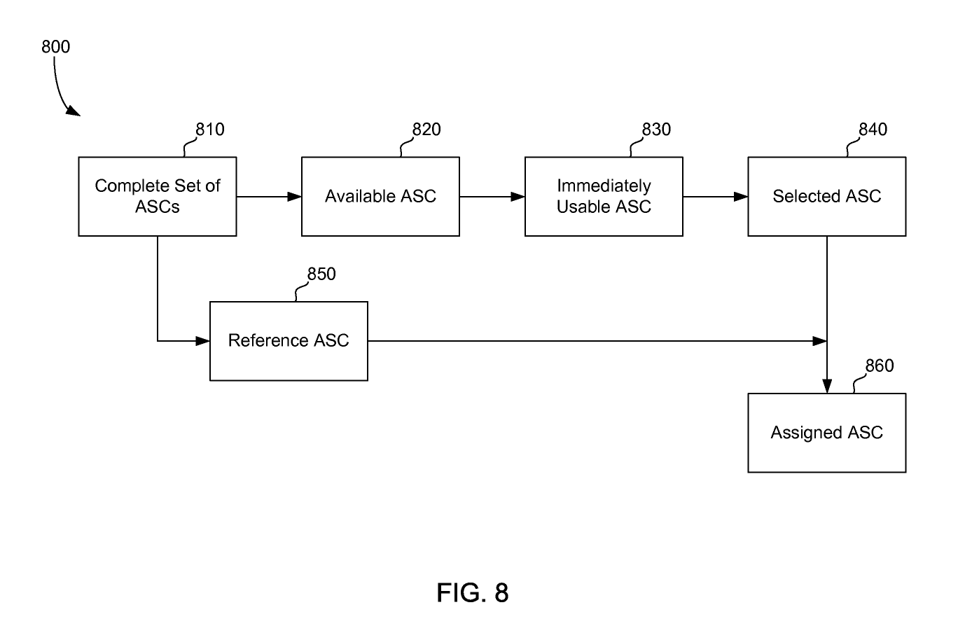

FIG. 8 is a flowchart diagram illustrating an example of an ASC selection process 800 according to various embodiments. Referring to FIGS. 1-8, a set of at least one available ASC 820 may be selected from a complete set of ASCs 810 (e.g., at block B720) based on a SIM configuration. A reference ASC 850 may be selected from the complete set of ASCs 810 based on priority associated with the data block (e.g., at block B710). From the set of at least one available ASC 820, at least one immediately usable ASC 830 may be selected, based on the random number and the persistence delay number of each of the at least one available ASC 820 (e.g., at blocks B730-B740).

From the at least one immediately usable ASC, at least one selected ASC 840 may be determined based on activities of the second RAT (e.g., at block B750). From the at least one selected ASC 840, an assigned ASC 860 may be selected based on priority levels associated with the reference ASC 850 and each of the at least one selected ASC 840 (e.g., at block B770).

While the embodiments reference WCDMA as the first RAT, one of ordinary skill in the art would appreciate that the optimized scheduling processes as described herein may be implemented for various RATs having similar processes. Similarly, the second RAT may be any RAT or activities causing de-sensing to the first RAT. For example, examples of the second RAT may include, but are not limited to, GSM/GPRS, WCDMA, LTE, and the like.

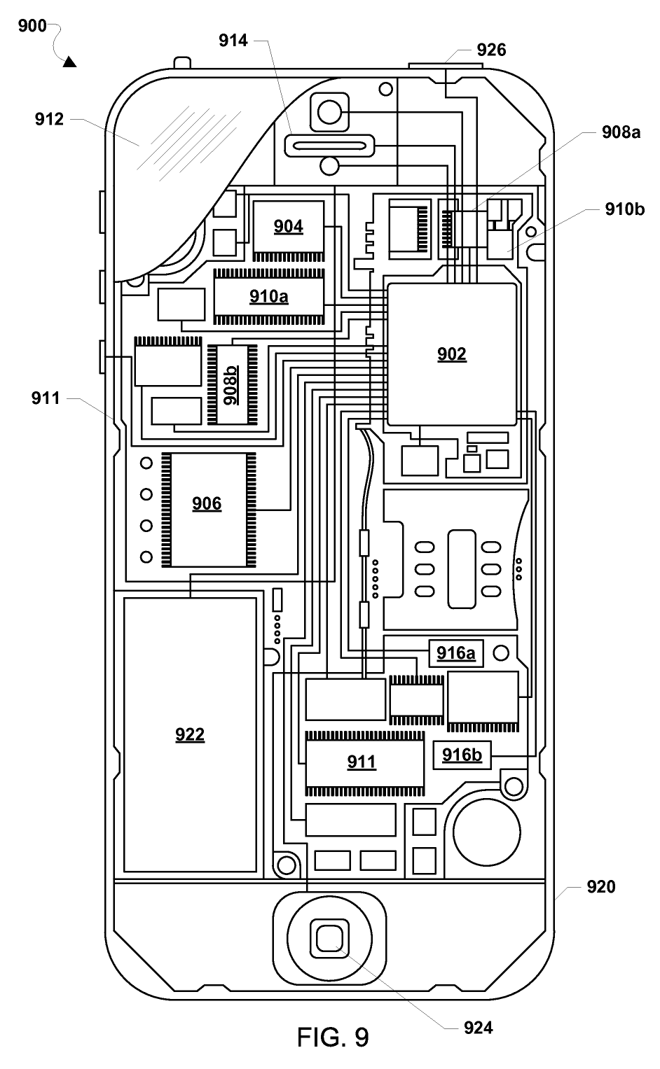

The various embodiments may be implemented in any of a variety of UE 200, an example of which is illustrated in FIG. 9, as a UE 900. As such, the UE 900 may implement the process and/or the apparatus of FIGS. 1-8, as described herein.

With reference to FIGS. 1-9, the UE 900 may include a processor 902 coupled to a touchscreen controller 904 and an internal memory 906. The processor 902 may be one or more multi-core integrated circuits designated for general or specific processing tasks. The memory 906 may be volatile or non-volatile memory, and may also be secure and/or encrypted memory, or unsecure and/or unencrypted memory, or any combination thereof. The touchscreen controller 904 and the processor 902 may also be coupled to a touchscreen panel 912, such as a resistive-sensing touchscreen, capacitive-sensing touchscreen, infrared sensing touchscreen, etc. Additionally, the display of the UE 900 need not have touch screen capability.

The UE 900 may have one or more cellular network transceivers 908a, 908b coupled to the processor 902 and to two or more antennae 910 and configured for sending and receiving cellular communications. The transceivers 908 and antennae 910a, 910b may be used with the above-mentioned circuitry to implement the various embodiment methods. The cellular network transceivers 908a, 908b may be the RF resources 218a, 218b, respectively. The antennae 910a, 910b may be the wireless antenna 220a, 220b. The UE 900 may include two or more SIM cards 916a, 916b, corresponding to SIM 1 204a and SIM 2 204b, coupled to the transceivers 908a, 908b and/or the processor 902. The UE 900 may include a cellular network wireless modem chip 911 (e.g., the baseband processor 216) that enables communication via a cellular network and is coupled to the processor.

The UE 900 may include a peripheral device connection interface 918 coupled to the processor 902. The peripheral device connection interface 918 may be singularly configured to accept one type of connection, or multiply configured to accept various types of physical and communication connections, common or proprietary, such as USB, FireWire, Thunderbolt, or PCIe. The peripheral device connection interface 918 may also be coupled to a similarly configured peripheral device connection port (not shown).

The UE 900 may also include speakers 914 for providing audio outputs. The UE 900 may also include a housing 920, constructed of a plastic, metal, or a combination of materials, for containing all or some of the components discussed herein. The UE 900 may include a power source 922 coupled to the processor 902, such as a disposable or rechargeable battery. The rechargeable battery may also be coupled to a peripheral device connection port (not shown) to receive a charging current from a source external to the UE 900. The UE 900 may also include a physical button 924 for receiving user inputs. The UE 900 may also include a power button 926 for turning the UE 900 on and off.

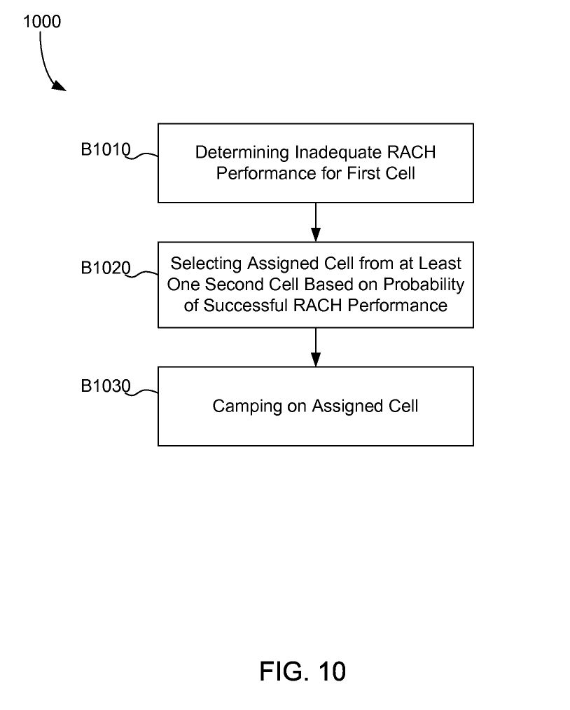

FIG. 10 is a flowchart diagram illustrating an example of a base station selection process 1000 according to various embodiments. The base station selection process 1000 may be executed by at least the scheduling unit 230 or other suitable processing units (e.g., the general processor 206, the baseband processor 216, and/or the like).

First at block B1010, the scheduling unit 230 may determine inadequate RACH performance for a first cell. The first cell may be a cell provided by the first base station 130. In some embodiments, the inadequate RACH performance may exist when various processes described herein do not yield an assigned ASC 860. Such may be the case when the set of at least one available ASC 820, the set of at least immediately usable ASC 830, or the set of at least one selected ASC 840 may be empty (for at least a predetermined period of time).

In a non-limiting example, no ASCs may be an immediately usable ASC 830 because none of the available ASCs is immediately transmittable (for a predetermined period of time). In another non-limiting example, no immediately usable ASC 830 may be selected as a selected ASC 840 given that no immediately usable ASC 830 may satisfy the predetermined tolerance rules based on the activities of the second RAT. At this point, camping on the first cell may not be feasible or efficient.

Next at block B1020, the scheduling unit 230 (e.g., the RRC) may select an assigned cell from at least one second cell based on a probability of successful RACH performance. The at least one second cell may be a cell provided by the second base station 140. Each of the at least one second cell may be different from the first cell. The second cell having the highest probability of successful RACH performance may be selected as the assigned cell. In some embodiments, the probability of successful RACH performance may be directly proportional the best possible AICH decode performance as described herein. For example, the probability of successful RACH performance for a given cell may be determined based on a number of immediately usable ASCs 830 (within a predetermined time period), a number of selected ASCs 840 yielded, the amount of overlap for each selected ASC 840 with respect to activities of the second RAT, and/or the like. The probability of successful RACH performance for each of the at least one second cell may be compared.

Lastly at block B1030, the scheduling unit 230 may output an indication message for the UE 110 to camp on the assigned cell for data communication.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Various modifications to embodiments described herein will be readily apparent to those skilled in the art, and the generic principles defined herein may be applied to some embodiments without departing from the spirit or scope of the disclosure. Thus, the present disclosure is not intended to be limited to the embodiments shown herein but is to be accorded the widest scope consistent with the following claims and the principles and novel features described herein.

What is claimed is:

1. A method, comprising:
determining a first set of at least one access service class (ASC) associated with a first radio access technology (RAT) based on persistence delay results;
selecting, from the first set of at least one ASC, a second set of at least one ASC based on activities of a second RAT; and
selecting, from the second set, an assigned ASC based on priority of a data block, the data block being transmittable via the first RAT.

2. The method of claim 1, wherein the first RAT is Wideband Code Division Multiple Access (WCDMA).

3. The method of claim 2, wherein the second RAT is Global System for Mobile Communications (GSM) or General Packet Radio Service (GPRS).

4. The method of claim 1, further comprises determining a third set of ASCs based on subscriber identity module (SIM) configuration, wherein the first set is selected from the third set of ASCs.

5. The method of claim 1, wherein the persistence delay results are determined based on a persistence delay number associated with each ASC in the first set.

6. The method of claim 5, wherein each ASC in the first set has a persistence delay number greater than a random number.

7. The method of claim 1, wherein each ASC in the first set is transmittable without standing by for persistence delay.

8. The method of claim 1, wherein selecting the assigned ASC based on priority of a data block comprises selecting a reference ASC based on priority of the data block, wherein the priority of the reference ASC is the same as the priority of the data block.

9. The method of claim 1, wherein:
selecting the assigned ASC based on priority of a data block further comprises determining the assigned ASC based on the reference ASC; and
a difference between the priority of the assigned ASC and the priority of the reference ASC is less than a difference between priority of any ASC in the second set and the priority of the reference ASC.

10. The method of claim 1, wherein selecting the second set based on activities of a second RAT comprises determining an overlap between activities of the second RAT and ASC activities of the first RAT.

11. The method of claim 10, wherein selecting the second set based on activities of a second RAT further comprises selecting each of the second set from the first set when the overlap between ASC activities of each of the second set and the activities of the second RAT is below a predetermined threshold.

12. The method of claim 1, wherein the first RAT is undergoing a random access channel (RACH) process.

13. A user equipment (UE), the UE comprising:
a scheduling unit, the scheduling unit is configured to:
determine a first set of at least one access service class (ASC) associated with a first radio access technology (RAT) based on persistence delay results;
select, from the first set of at least one ASC, a second set of at least one ASC based on activities of a second RAT; and
select, from the second set, an assigned ASC based on priority of a data block, the data block being transmittable via the first RAT.

14. The UE of claim 13, the scheduling unit is further configured to determine a third set of ASCs based on subscriber identity module (SIM) configuration, wherein the first set is selected from the third set.

15. The UE of claim 13, wherein the persistence delay results are determined based on a persistence delay number associated with each ASC in the first set.

16. The UE of claim 15, wherein each ASC in the first set has a persistence delay number greater than a random number.

17. The UE of claim 13, wherein each ASC in the first set is transmittable without standing by for persistence delay.

18. The UE of claim 13, wherein selecting the assigned ASC based on priority of a data block comprises selecting a reference ASC based on priority of the data block, wherein the priority of the reference ASC is the same as the priority of the data block.

19. The UE of claim 13, wherein:
selecting the assigned ASC based on priority of a data block further comprises determining the assigned ASC based on the reference ASC; and
a difference between the priority of the assigned ASC and the priority of the reference ASC is less than a difference between priority of any ASC in the second set and the priority of the reference ASC.

20. The UE of claim 13, wherein selecting the second set based on activities of a second RAT comprises determining an overlap between activities of the second RAT and ASC activities of the first RAT.

21. The UE of claim 20, wherein selecting the second set based on activities of a second RAT further comprises selecting each of the second set from the first set when the overlap between ASC activities of each of the second set and the activities of the second RAT is below a predetermined threshold.

22. The UE of claim 13, wherein the first RAT is undergoing a random access channel (RACH) process.

23. A system, the system comprising:
means for determining a first set of at least one access service class (ASC) associated with a first radio access technology (RAT) based on persistence delay results;
means for selecting, from the first set of at least one ASC, a second set of at least one ASC based on activities of a second RAT; and
means for selecting, from the second set, an assigned ASC based on priority of a data block, the data block being transmittable via the first RAT.

24. A method, comprising:
determining inadequate random access channel (RACH) performance for a first cell;
selecting an assigned cell from at least one second cell based on probability of successful RACH performance; and
camping on the assigned cell.

25. The method of claim 24, further comprising:
determining, for the first cell, a first set of at least one access service class (ASC) associated with a first radio access technology (RAT) based on persistence delay results;
selecting, from the first set, a second set of at least one ASC based on activities of a second RAT; and
selecting, from the second set, a first assigned ASC based on priority of a data block, the data block being transmittable via the first RAT serviced by the first cell.

26. The method of claim 25, wherein inadequate RACH performance for the first cell is determined when at least one of: the first set fails to be determined, the second set fails to be determined; and the first assigned ASC associated with the first cell fails to be determined.

27. The method of claim 24, further comprising:
determining a fourth set of at least one ASC associated with a first RAT based on persistence delay results for each of the at least one second cell;
selecting, from the fourth set, a fifth set of at least one ASC based on activities of a second RAT; and
selecting, from the fifth set, a second assigned ASC for each of the at least one second cell based on priority of a data block, the data block being transmittable via the first RAT.

28. The method of claim 27, wherein the probability of successful RACH performance for each of the at least one second cell is determined based on the second assigned ASC.

29. The method of claim 28, wherein the probability of successful RACH performance for each of the at least one second cell is compared.

30. The method of claim 29, wherein one of the at least one second cell having highest probability of successful RACH performance associated with the second assigned ASC associated with the one of the at least one second cell is selected.
